(19) United States
(12) Patent Application Publication
(10) Pub. No.: US 2012/0044602 A1
(43) Pub. Date: Feb. 23, 2012

(54) REGULATING SYSTEM HAVING OVERVOLTAGE PROTECTION CIRCUIT AND OVERCURRENT PROTECTION CIRCUIT

(75) Inventor: YONG-ZHAO HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/965,727

(22) Filed: Dec. 10, 2010

(30) Foreign Application Priority Data
Aug. 23, 2010 (CN) 201010259951.2

(51) Int. Cl. H02H 9/00

(52) U.S. Cl. 361/18

(57) ABSTRACT

A regulating system includes an input port, an output port; and an overvoltage protection circuit. The an overvoltage protection circuit includes a fuse, a semiconductor controlled rectifier (SCR), a first resistor, and a voltage regulator. The fuse includes a first end and a second end. The SCR includes a gate, an anode, and a cathode. The regulator includes a cathode and an anode. The first end of the fuse is connected to the input port, the second end of the fuse is connected to the anode of the SCR, the cathode of the SCR is connected to the ground, the gate of the SCR is connected to the anode of the regulator through the first resistor, the cathode of the regulator is connected to the output port.

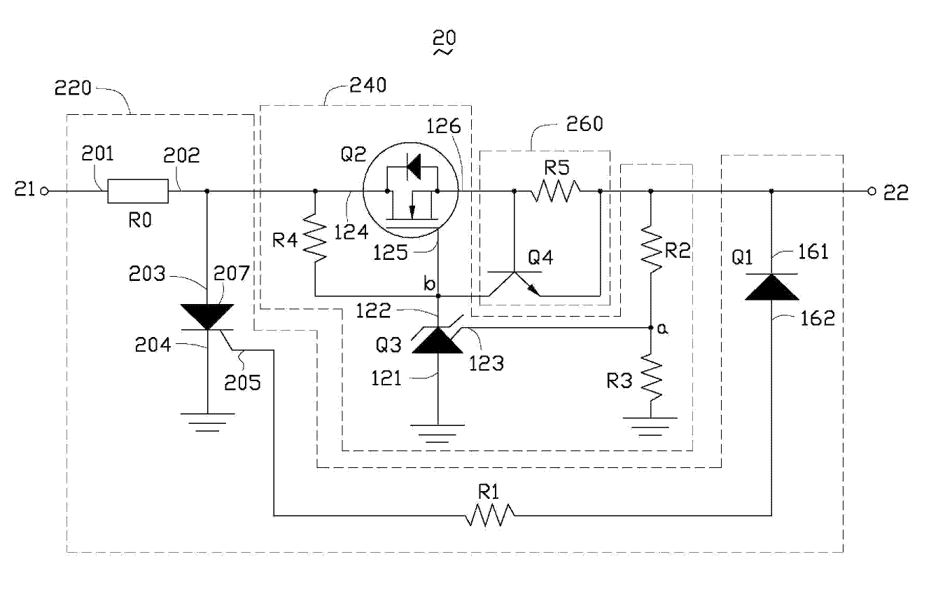

### BACKGROUND

1. Technical Field

The present disclosure relates to regulating systems and, particularly, to a regulating system having an overvoltage protection circuit and an overcurrent protection circuit.

2. Description of Related Art

Power circuits are widely used in various electronic products such as computers notebooks, and LCD monitors. Most current power circuits have a complicated configuration to include a regulating system with an overvoltage protection circuit and an overcurrent protection circuit for regulating output voltage of the power circuits.

Therefore, it is desirable to provide a new regulating system which can overcome the above-mentioned limitations.

### BRIEF DESCRIPTION OF THE DRAWING

Many aspects of the present disclosure should be better understood with reference to the following drawing. The components in the drawing are not necessarily drawn to scale, the emphasis instead being placed upon clearly illustrating the principles of the present disclosure.

The FIGURE shows a circuit diagram of a regulating system according to an exemplary embodiment.

### DETAILED DESCRIPTION

Embodiments of the present disclosure will now be described in detail with reference to the drawing.

The FIGURE shows a regulating system 20, according to an exemplary embodiment of the present disclosure. The regulating system 20 includes an input port 21 and an output port 22. The regulating system 20 further includes an overvoltage protection circuit 220, a regulating circuit 240, and an overcurrent protection circuit 260.

The overvoltage protection circuit 220 includes a fuse R0, a semiconductor controlled rectifier (SCR) 207, a first resistor R1, and a voltage regulator Q1. The fuse R0 includes a first end 201 and a second end 202. The SCR 207 includes an anode 203, a cathode 204, and a gate 205. When a working voltage is added on the gate 205, the anode 203 will be electronically connected to the cathode 204. The voltage regulator Q1 includes a cathode 161 and an anode 162. The first end 201 of the fuse R0 is connected to the input port 21. The second end 202 of the fuse R0 is connected to the anode 203 of the SCR 207. The cathode of the SCR 207 is connected to the ground. The gate 205 of the SCR is connected to the anode 162 of the voltage regulator Q1 through the first resistor R1. The cathode of the voltage regulator Q1 is connected to the output port 22.

The regulating circuit 240 includes a metal oxide semiconductor (MOS) transistor Q2, a second resistor R2, a third resistor R3, a fourth resistor R4, and a regulating unit Q3. The MOS transistor Q2 includes a drain electrode 124, a gate electrode 125, and a source electrode 126. The regulating unit Q3 includes an anode 121, a cathode 122, and a reference terminal 123. The regulating unit Q3 is capable of automatically adjusting a voltage of the cathode 122 according to a voltage of the reference terminal 123. In one embodiment, the voltage of the cathode 122 increases following a voltage decrease of the reference terminal 123 and decreases following a voltage increase of the reference terminal 123. The regulating unit Q3 is a three-terminal adjustable voltage regulator.

The drain electrode 124 of the MOS transistor Q2 is connected to the second end 202 of the fuse R0. The gate electrode 125 of the MOS transistor Q2 is connected to the cathode 122 of the regulating unit Q3 and is connected to the second end 202 of the fuse R0 via the fourth resistor R4. The second resistor R2 and the third resistor R3 are connected in series between the output port 22 and the ground. The anode 121 of the regulating unit Q3 is grounded. The reference terminal 123 of the regulating unit Q3 connects to a node “a” between the first second resistor R2 and the third resistor R3.

The overcurrent protection circuit 260 includes a first bipolar transistor Q4 and a fifth resistor R5. An emitter of the bipolar transistor Q4 is connected to the output port 22. A collector of the bipolar transistor Q4 is connected to the gate electrode 125 of the MOS transistor Q2. A base of the bipolar transistor Q4 is connected to the source electrode 126 of the MOS transistor Q2 and is also connected to the output port 22 via the fifth resistor R5. In one embodiment, the bipolar transistor Q4 is an NPN bipolar transistor.

The node “a” between the first resistor R1 and the second resistor R2 is defined to be a first reference point. A node “b” between the gate electrode 125 of the MOS transistor Q2 and the cathode 122 of the regulating unit Q3 is defined to be a second reference point.

In operation, the input port 21 receives a power supply from an external circuit (not shown). The regulating system 20 generates an output voltage which is output from the output port 22.

When the output voltage of the output port 22 decreases, a first reference voltage of the first reference point “a”, which is a divided voltage of the output voltage, is correspondingly decreased. Since the reference terminal 123 of the regulating unit Q3 is connected to the first reference point “a”, the voltage of the second reference point “b” increases following a voltage decrease of the reference terminal 123. Therefore, a voltage of the source electrode of the MOS transistor Q2 correspondingly increases based on the characteristic of the MOS transistor Q2, so as to compensate for the voltage decrease of the first output terminal 14a.

On the contrary, when the output voltage of the output port 22 increases, the first reference voltage of the first reference point “a” is correspondingly increased. The voltage of the cathode 122 of the regulating unit Q3 correspondingly decreases and the voltage of the source electrode of the MOS transistor Q2 correspondingly decreases to compensate for the voltage increase of the first output terminal 14a.

Because voltage between the base and the emitter of the bipolar transistor Q4 is approximately equal to 0.7V, the bipolar transistor Q4 turns on when the current flowing through the fifth resistor R5 increases to reach 0.7V divided by a resistance value “r5” of the fifth resistor R5, namely 0.7V/r5. That is, the maximum voltage across the fifth resistor R5 is limited to be 0.7V by the bipolar transistor Q4, a maximum current flowing through the fourth resistor R4 is approximately equal to 0.7V/r5. Therefore, the maximum current output from the output port 14 is also limited to 0.7V/r5 to achieve overcurrent protection function.

When the output voltage of the output port 22 increases to a breakdown voltage of the voltage regulator Q1. The voltage regulator Q1 will then be broken down and the output voltage will load on the gate 205 of the SCR 207, thereby turning on the SCR 207. In this case, the second end 202 of the fuse R0 is connected to the ground, which leads to the fuse R0 to perform an overvoltage protection function.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A regulating system, comprising:
an input port;
an output port; and
an overvoltage protection circuit comprising a fuse, a semiconductor controlled rectifier (SCR), a first resistor, and a voltage regulator; the fuse comprising a first end and a second end, the SCR comprising a gate, an anode, and a cathode, the regulator comprising a cathode and an anode, the first end of the fuse connected to the input port, the second end of the fuse connected to the anode of the SCR, the cathode of the SCR connected to the ground, the gate of the SCR connected to the anode of the regulator through the first resistor, the cathode of the regulator connected to the output port.

2. The regulating system of claim 1, comprising a regulating circuit, wherein the regulating circuit comprises a metal oxide semiconductor (MOS) transistor, a second resistor, a third resistor, a fourth resistor, and a regulating unit, the second resistor and the third resistor are connected in series between the output port and the ground, a reference terminal of the regulating unit is connected to a node between the second resistor and the third resistor, an anode of the regulating unit is grounded, a cathode of the regulating unit is connected to the second end of the fuse via the fourth resistor, a gate electrode of the MOS transistor is connected to the cathode of the regulating unit, a drain electrode of the MOS transistor is connected to the input port, the source electrode of the MOS transistor is connected to the output port via the overcurrent protection circuit.

3. The regulating system of claim 2, wherein the regulating unit is a three-terminal adjustable voltage regulator.

4. The regulating system of claim 3, wherein the regulating unit automatically adjusts a voltage of the cathode thereof according to a voltage of the reference terminal.

5. The regulating system of claim 4, wherein voltage of the cathode of the regulating unit increases following a voltage decrease of the reference terminal of the regulating unit, voltage of the cathode of the regulating unit decreases following a voltage increase of the reference terminal of the regulating unit.

6. The regulating system of claim 2, further comprising an overcurrent protection circuit, wherein the overcurrent protection circuit comprises a bipolar transistor and a fifth resistor, wherein an emitter of the bipolar transistor is connected to the output port, a collector of the bipolar transistor is connected to the gate electrode of the MOS transistor, a base of the bipolar transistor is connected to the source electrode of the MOS transistor and is connected to the output port via the fifth resistor.

7. The regulating system of claim 6, wherein the bipolar transistor is an NPN bipolar transistors.
